(19) United States
(12) Patent Application Publication
(10) Pub. No.: US 2013/0232315 A1
(43) Pub. Date: Sep. 5, 2013

(54) SCALABLE, CUSTOMIZABLE, AND LOAD-BALANCING PHYSICAL MEMORY MANAGEMENT SCHEME

(71) Applicants: Chen TIAN, Union City, CA (US); Daniel G. WADDINGTON, Morgan Hill, CA (US)

(72) Inventors: Chen TIAN, Union City, CA (US); Daniel G. WADDINGTON, Morgan Hill, CA (US)

(73) Assignee: Samsung Electronics Co., Ltd., Suwon City (KR)

(21) Appl. No.: 13/411,148

(22) Filed: Mar. 2, 2012

(51) Int. Cl. G06F 12/02

(52) U.S. Cl. 711/170; 711/E12.059; 711/E12.002

(57) ABSTRACT

A physical memory management scheme for handling page faults in a multi-core or many-core processor environment is disclosed. A plurality of memory allocators is provided. Each memory allocator may have a customizable allocation policy. A plurality of pagers is provided. Individual threads of execution are assigned a pager to handle page faults. A pager, in turn, is bound to a physical memory allocator. Load balancing may also be provided to distribute physical memory resources across allocators. Allocations may also be NUMA-aware.

### FIELD OF THE INVENTION

The present invention is generally directed to improving physical memory allocation in multi-core processors.

### BACKGROUND OF THE INVENTION

Physical memory refers to the storage capacity of hardware, typically RAM modules, installed on the motherboard. For example, if the computer has four 512 MB memory modules installed, it has a total of 2 GB of physical memory. Virtual memory is an operating system feature for memory management in multi-tasking environments. In particular, virtual addresses may be mapped to physical addresses in memory. Virtual memory facilitates a process using a physical memory address space that is independent of other processes running in the same system.

When software applications, including the Operating System (OS), are executed on a computer the processor of the computer stores the runtime state (data) of applications in physical memory. To prevent conflicts on the use of physical memory between different applications (processes), the OS must manage physical memory (i.e., allocation and de-allocation) effectively and efficiently. Typically, a single data structure is used to book-keep the information about which part of memory has been used and which has not. The term “allocator” is used to describe the data structure and allocation and de-allocation methods.

Referring to FIG. 1, a processor accesses a virtual address. A page table stores the mapping between virtual addresses and physical addresses. A lookup is performed in a page table to determine a physical address for a particular virtual address. A page fault exception is raised when accessing a virtual address that is not backed up by physical memory. The faulting application's state is saved and the page fault handler is called. For a given virtual address, the page fault handler looks for an available physical page and inserts a new mapping into the page table and execution of the faulting application is resumed. Conventionally, the page fault handler is the client of a single physical memory allocator.

With the invention of multi-core and many-core processors, new challenges have been posted to physical memory management. First, many conventional physical memory management schemes do not scale well. In the context of multi-core or many-core processors, several applications may request physical memories simultaneously if they are running on different cores. The data structure used for managing physical memory must be accessed exclusively. As a result, memory allocation and de-allocation requests have to be handled sequentially, which leads to scalability limitations (i.e., access is serialized). Second, existing operating systems do not allow the customization of memory management schemes. Existing memory management techniques do not always give the best performance for all applications. It is important to allow the coexistence of different techniques when different software applications are running on different processor cores. Additionally, care must be taken to load-balance across physical modules (and thus reduce contention and improve performance) when several schemes are deployed at the same time.

### SUMMARY OF THE INVENTION

A physical memory management scheme for a multi-core or many-core processing system includes a plurality of separate memory allocators, each assigned to one or more cores. An individual allocator manages a subset of the entire physical memory space and services memory allocation requests associated with page faults. In one embodiment the memory allocation can be determined based on hardware architecture and be NUMA-aware. When an application thread requests or releases some physical memory, a “local” allocator that is assigned to the core on which the thread resides is used to service the request, improving scalability.

In one embodiment an allocator can have different data structures and allocation/de-allocation methods to manage the physical memory it is responsible for (e.g., slab, buddy, AVL tree). In one embodiment an application can customize the allocator via the page fault handler and a memory management API.

In one embodiment each allocator monitors its workload and the allocators are arranged to work cooperatively in order to achieve load balancing. Specifically, a lightly-loaded allocator (in terms of amount of quota allocated) can donate some of its unused quota memory to more heavily-loaded allocators.

### BRIEF DESCRIPTION OF THE DRAWINGS

FIG. 1 illustrates page fault handling in accordance with the prior art.

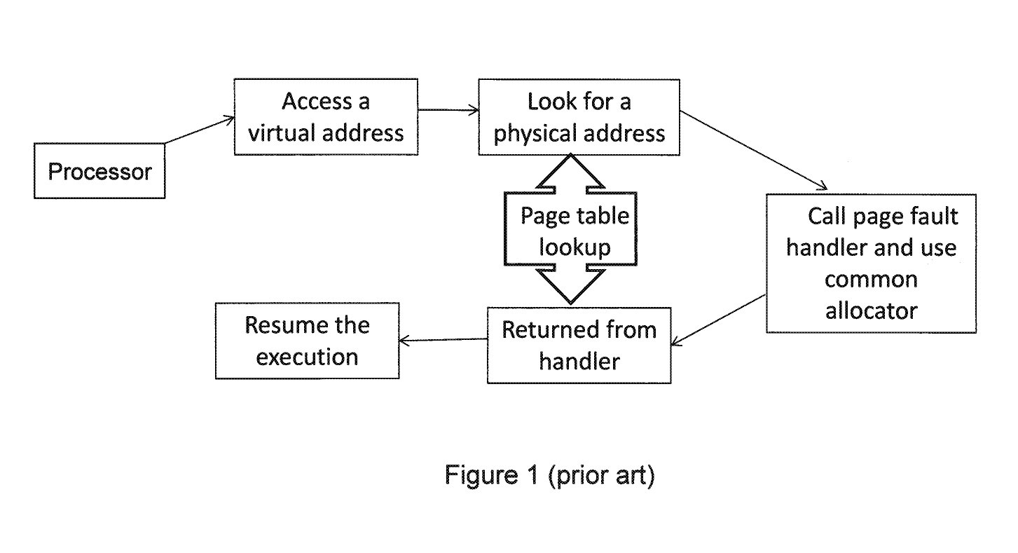

FIG. 2A illustrates an exemplary multi-core system environment for practicing memory management with two or more memory allocators in accordance with an embodiment of the present invention.

FIG. 2B illustrates the binding of applications to a set of pagers and the binding of pagers to a plurality of memory allocators in accordance with an embodiment of the present invention.

FIG. 3 illustrates load-balancing, customizability, and NUMA-aware capabilities in accordance with an embodiment of the present invention.

FIG. 4 illustrates a method of configuring pagers and memory allocators in accordance with the present invention.

FIG. 5 illustrates page fault handling in accordance with an embodiment of the present invention.

### DETAILED DESCRIPTION

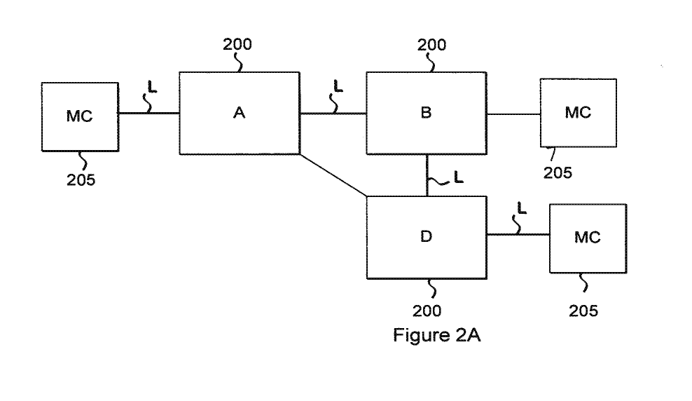

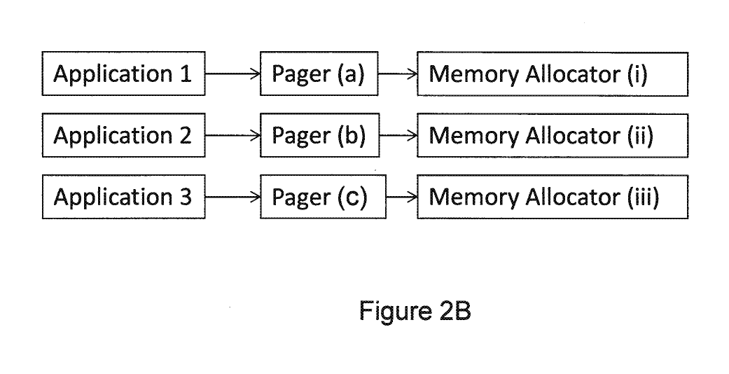

FIG. 2A illustrates a general system environment to explain aspects of the present invention. A multi-core processor system includes a plurality of processor cores 200 (A, B, and C) linked together with links (L). The processor cores may be implemented on a single chip in a multi-core or many-core implementation. However, more generally, individual cores may be located on one or more different chips. There are also physical memory controllers 205 (MC) for the cores to access physical memory. The total physical memory space includes all of the different physical memories coupled to the memory controllers.

The architecture may further have a Non-Uniform Memory Access (NUMA) architecture where by “cost” of accessing memory depends upon the location of the physical memory with respect to hardware topology. Additionally, different types of physical memory may also be utilized (e.g., non-volatile, low-energy). The processor system is multi-threaded and uses a virtual memory addressing scheme to access physical memory in which there is a page table (not shown) and the resolving of page faults includes finding available pages, which in turn requires memory allocation.

FIG. 2B illustrates how individual applications are assigned (bound) to an individual pager in a set of pagers. The pagers (page fault handlers) are those processes that resolve page faults. That is a pager is a service routine that is invoked when the processor needs to find a portion of memory for an application. The pagers are thus clients of the memory allocators. Consequently, in one embodiment an individual pager is bound to a default memory allocator. Thus, an individual thread of an application has an association with a pager which in turn has an association with a memory allocator such that when an individual thread has a page fault it may be assigned a pager and a memory allocator.

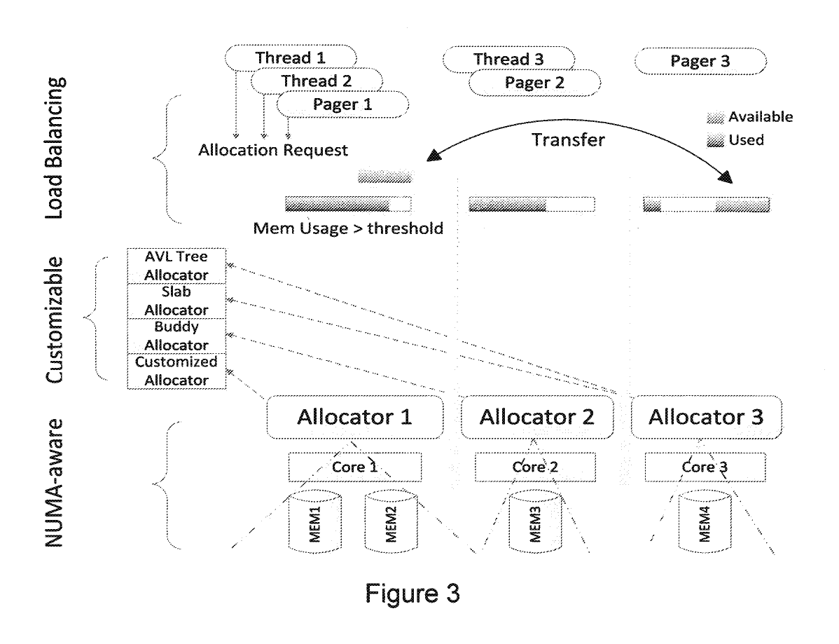

FIG. 3 is a high level diagram illustrating aspects of how threads, pagers, memory allocators, processor cores, and physical memory interact and may be used to support different aspects, such as the possibility of load balancing (if chosen), customizability (if chosen), and NUMA-aware operation (if chosen). The total physical memory space associated with the external physical memories (e.g., MEM1-MEM4) is split into a set of M allocators and configured for an M-to-N mapping where N is the number of cores. Each memory allocator is thus assigned to one or more cores although in one embodiment there is at one memory allocator per core.

An individual allocator manages a subset of the entire physical memory space available. This can be determined based on the hardware architecture or some predefined system configuration. When an application thread requests or releases a portion of the physical memory the “local” allocator that is assigned to the core on which the thread resides is used to service the request. This avoids the need to perform inter-core communications and thus helps improve scalability.

Each allocator can have different data structures and allocation/de-allocation methods to manage the physical memory it is responsible for (e.g., well-known allocation methods such as a slab allocator, buddy allocator, or AVL tree allocator). Additionally, a customized allocator method may be used by an individual allocator. An application can configure the allocator via the page fault handler (a service routine that is invoked when the processor needs to find a portion of memory for an application) or some explicit memory management API. This provides flexibility to allow customization of the system in order to meet specific application requirements.

In one embodiment each allocator monitors its workload (i.e., how much memory it has allocated) with respect to an assigned quota/physical area. Allocators are arranged to work cooperatively in order to achieve load balancing. Specifically, a lightly-loaded allocator (in terms of the amount of quota allocated) can donate a portion of its unused quota memory to more heavily-loaded allocators.

In a preferred embodiment each pager is a microkernel-based page fault handler implementation where the microkernel is a thin layer providing a service for page fault handling redirection to user-space. The microkernel also includes page table data structures for each process running in the system. Microkernel architectures generally allow pagers to execute in user-space. Additionally, the allocators can also reside in user-space. This is advantageous because it permits customization of the allocators without modifying the operating system per se. Specifically, when a processor detects a page fault of an application thread, which indicates a new physical memory allocation request needs to be serviced, it sends the page fault information to a pager, which is bound to one or more allocators. For example a protocol associating application threads and a memory allocator can be implemented through the pager.

The present invention is highly scalable because it does not use a single centralized memory allocator data structure for physical memory management. That is, as the number of cores increases the number of memory allocators can also be increased.

Embodiments of the present invention can be implemented to have the memory allocation be aware of any Non-Uniform Memory Access (NUMA) properties that any underlying platform may have. In a NUMA-aware implementation the system realizes the hardware characteristics and attempts to allocate memory from the “least cost” (e.g., according to a metric such as lowest latency) memory bank for an application.

Embodiments of the present invention are customizable because application specific allocation schemes are enabled (e.g., through a pager). This allows users to define or choose the best memory allocation scheme for their applications. For example, customization may include using different data structures to manage physical memory or using different allocation algorithms.

Embodiments of the present invention also support load-balancing. This allows physical memory to be used efficiently to achieve better throughput. Load balancing allows free memory to be donated to a heavily used allocator. Given a per-core-allocator scheme, a heavily-used allocator may borrow some memory from adjacent allocators.

### Exemplary Steps for Construction of Memory Allocators and Pagers

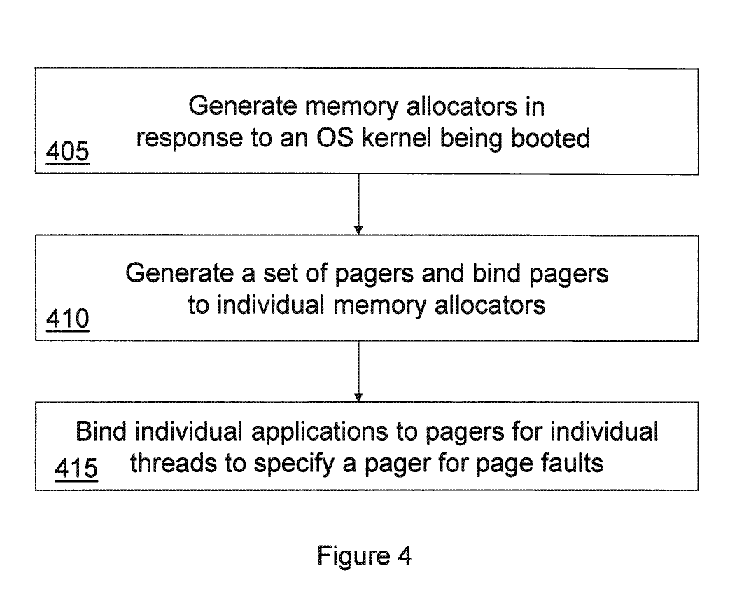

FIG. 4 illustrates an exemplary method of configuring memory allocators and pagers. In one implementation memory allocators are constructed when an OS kernel is booted (step 405). When an OS kernel is booted, it automatically identifies hardware information/topology and initializes allocators accordingly. Example information needed to drive allocator initialization includes total size of memory, number of memory controllers and NUMA characteristics. Based on the information, the number of memory allocators and the memory space managed by each allocator can be determined. These allocators are initialized and assigned to different cores to achieve an M-to-N mapping where N is the number of cores and M is the number of allocators.

A set of pagers is also constructed and bound to individual memory allocators (step 410). The number of pagers may be customized but there is preferably at least one for each core in order to achieve good scalability. Therefore, a set of pagers needs to be created, and a memory allocator assigned to each of them. To achieve scalability, it is preferable to create at least one pager for each core, and bind these pagers with the allocator assigned to the same core. More generally, the mapping between pagers and memory allocators can be M-to-N.

Applications are also bound to pagers (step 415). Application threads generate page faults. Therefore, each thread needs to specify a pager to resolve any page faults. Similar to step 410, a pager is bound to a thread if they are running on the same core.

After steps 410 and 415, an application thread can communicate with an allocator about what kind of allocation (i.e., internal data structure, allocation methods etc.) it needs through the pager. Therefore, a set of protocols can be pre-defined for this purpose.

### Operation Examples

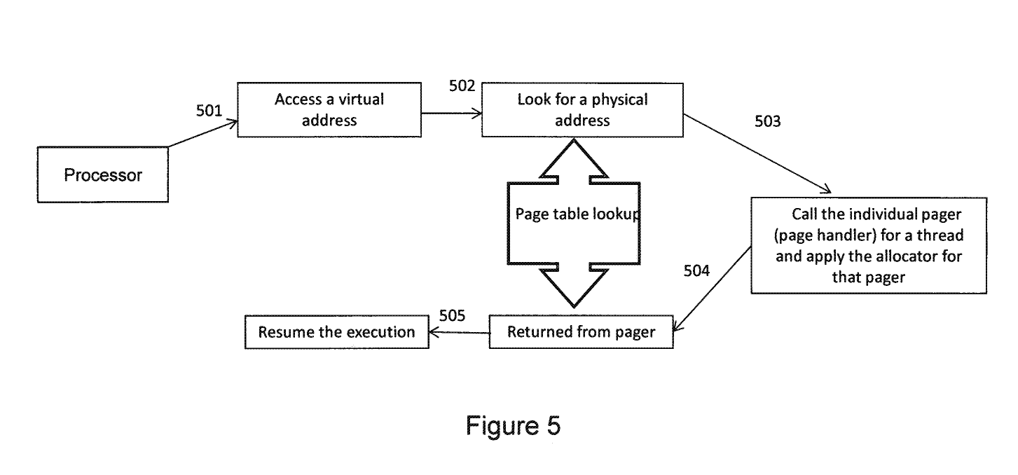

Consider first the servicing of a normal request. Referring to FIG. 5, page fault handling differs from the prior art because individual pagers are bound to individual applications. Each pager, in turn, is bound to an individual memory allocator. When a page fault is sent to a pager from an application thread via the kernel, the pager searches for the right allocator and invokes its allocation method to get a portion of physical memory for applications. Similarly, when the kernel informs the pager that a thread is destroyed, it invokes the de-allocation method of the respective allocator to return previously allocated memory.

In particular a processor accesses a virtual address in step 501. A page table stores the mapping between virtual addresses and physical addresses. A lookup is performed in a page table in step 502 to determine a physical address for a particular virtual address. A page fault exception is raised when accessing a virtual address that is not backed up by physical memory. The faulting application's state is saved and the pager is called in step 503. The particular pager that is called is based on the association between applications and pagers. For a given virtual address, the selected pager makes an allocation request to a memory allocator, and looks for an available physical page. A new mapping is returned and inserted into the page table in step 504 and execution of the faulting application is resumed in step 505.

As previously described, in one embodiment a memory allocator may be customized Consider now the servicing of a customization request. Besides servicing normal allocation/de-allocation requests, in one embodiment each allocator also provides a set of APIs through which pagers can configure the internal data structure and allocation/de-allocation methods. Different algorithms can be used. Applications can send desired allocation algorithms through pagers or through explicit API calls.

Finally, consider the servicing of a load balance request. In one embodiment each allocator can service load balance requests. After servicing an allocation request, each allocator compares the size of the available memory with a threshold value. If the size it is too low, it will make a request for additional memory to other memory allocators. An allocator that has maximum available memory with a light-load can donate part of managed memory to the request. Different policies can be applied to determine how much is donated. For example, half of the total amount of available memory or twice of the requested amount can be donated. The donated memory should be returned when the work load gets lighter.

Note that an embodiment of the present invention supports the combination of load-balancing, customization, and NUMA-awareness. Additionally, scalability is supported. The features are individually very attractive but of course the combination of features is particularly attractive for many use scenarios.

In accordance with the present invention, the components, process steps, and/or data structures may be implemented using various types of operating systems, programming languages, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. The present invention may also be tangibly embodied as a set of computer instructions stored on a computer readable medium, such as a memory device.

The various aspects, features, embodiments or implementations of the invention described above can be used alone or in various combinations. The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A method of physical memory management in a multi-threaded, multi-core processing system, comprising:
handling a page fault exception for a thread by selecting a pager for the thread from a plurality of pagers;
selecting a physical memory allocator from a plurality of physical memory allocators by accessing an allocator bound to the selected pager; and
receiving an allocation of a portion of physical memory in response to an allocation request in order to resolve the page fault exception for the thread.

2. The method of claim 1, wherein each of the plurality of physical memory allocators is customizable.

3. The method of claim 1, wherein at least one physical memory allocator is assigned to each processor core.

4. The method of claim 1, further comprising providing load balancing by transferring a physical memory allocation request from an allocator that is different from the allocator bound to the pager.

5. The method of claim 1, wherein the multi-core processors are configured to have a Non-Uniform Memory Access architecture and the method further comprises at least one physical memory allocator which allocates physical memory from a least cost memory bank for an application.

6. The method of claim 1, wherein an application is bound to a pager.

7. The method of claim 1, wherein a pager is bound to a physical memory allocator.

8. A computer program product comprising computer program code stored on a non-transitory computer readable medium, which when executed on a processor implements a method, comprising:
handling a page fault exception for a thread by selecting a pager from a plurality of pagers by accessing a pager bound to the application associated with the thread; and
selecting a memory allocator from a plurality of memory allocators by accessing a memory allocator bound to the selected pager to receive an allocation of a portion of physical memory in response to an allocation request in order to resolve the page fault exception.

9. The computer program product of claim 8, wherein each of the plurality of memory allocators is customizable.

10. The computer program product of claim 8, wherein at least one memory allocator is assigned to each processor core.

11. The computer program product of claim 8, further comprising providing load balancing by transferring a memory allocation request from a memory allocator different than the memory allocator bound to the pager.

12. The computer program product of claim 8, wherein the multi-core processors are configured to have a Non-Uniform Memory Access architecture and at least one physical memory allocator allocates memory from a least cost memory bank for an application.

13. The computer program product of claim 8, wherein an application is bound to a pager.

14. The computer program product of claim 8, wherein a pager is bound to a memory allocator.

15. A system, comprising:
a plurality of processor cores;
a physical memory space comprising a plurality of physical memories; and
a plurality of memory allocators for handling memory allocation requests associated with page faults from a plurality of pagers;
wherein the system is configured to assign memory allocators based on an association between threads, pagers, and memory allocators.

16. The system of claim 15, wherein each of plurality of physical memory allocators is customizable.

17. The system of claim 15, wherein at least one physical memory allocator is assigned to each processor core.

18. The system of claim 15, wherein the system is configured to provide load balancing by transferring a physical memory allocation request from a memory allocator different that the memory allocator bound to the pager.

19. The system of claim 15 wherein the multi-core processors are configured to have a Non-Uniform Memory Access architecture and at least one physical memory allocator allocates memory from the least cost memory bank for an application.
